(19) United States
(12) Patent Application Publication
(10) Pub. No.: US 2004/0258868 A1
(43) Pub. Date: Dec. 23, 2004

(54) Resealable multi-ply label

(76) Inventor: Joseph D. Franko SR., Ham Lake, MN (US)

Correspondence Address: NIKOLAI & MERSEREAU, P.A., 900 SECOND AVENUE SOUTH, SUITE 820, MINNEAPOLIS, MN, 55402, US

(21) Appl. No.: 10/896,203

(22) Filed: Jul. 21, 2004

Related U.S. Application Data
(63) Continuation-in-part of application No. 10/294,287, filed on Nov. 14, 2002, now abandoned.
Application No. 10/294,287 is a continuation-in-part of application No. 10/099,669, filed on Mar. 14, 2002.

(51) Int. Cl. B32B 9/00

(52) U.S. Cl. 428/40.1

(57) ABSTRACT

A resealable multi-ply label has a base ply having an under side and an upper side and an amount of an adhesive on the under side to attach the label to an object of interest to be labeled, an upper ply having an under side and an upper side wherein the upper side of the base ply and the under side of the upper ply are joined together along a hinge strip by an amount of a permanent adhesive material thereby forming a permanent hinge. The upper side of the base ply and the under side of the upper ply are releasably, resealably joined along at least a second edge spaced from the hinge strip using a release-reseal system including layers of a release coating and a pressure sensitive adhesive such that the plies can be separated and resealed.

### I. CROSS REFERENCE TO RELATED APPLICATIONS

The present application is a continuation-in-part of application Ser. No. 10/294,287, filed Nov. 14, 2002 which, in turn, is a continuation-in-part of application Ser. No. 10/099,669, filed Mar. 14, 2002. The above cross-referenced applications are deemed incorporated herein by reference in their entirety.

### II. FIELD OF THE INVENTION

The present invention relates generally to the field of labeling and, in particular, the present invention provides a multi-ply resealable label construction that requires a non-pressure sensitive adhesive hinge.

### III. Related Art

Multi-ply labels, variously referred to as “multi-layered” “extended text,” or “expanded content” or “booklet” labels, are useful for consumer products, particularly those sold in bottles, cans and cartons, where it is desirable to present additional information to the consumer which cannot conveniently be contained on a single printed label surface. Particularly in view of the increasing amount of governmental regulation and labeling requirements, many consumer products contained in such packaging must carry additional information including detailed instructions for use, detailed listings of the contents, a variety of consumer product warnings, and provisions for multi-lingual information. This has led to the provision of multi-ply labels carrying text on a plurality of surfaces. Such labels normally contain two or more layers or plies of label material hinged together using a pressure sensitive adhesive along one margin and utilizing a pressure sensitive reseal system along the opposite margin. For example, Hill et al in U.S. Pat. No. 5,149,587; Coward et al in U.S. Pat. No. 5,904,973 and Baum, Jr. et al in U.S. Pat. No. 6,254,137 show label constructions of this type.

These labels normally are constructed utilizing a pair of label layers or plies with pressure sensitive adhesive therebetween to provide a hinge along one edge. The pressure sensitive adhesive, however, remains tacky and subject to being pulled apart by users of the label. Furthermore, pressure sensitive adhesive hinges are often compromised by environmental conditions (e.g., mechanical forces, humidity, temperature fluctuations, and age). This is particularly true if the hinge is a narrow strip. This has led to the use of rather wide hinge strips between label layers which reduces the available text area on inner surfaces.

Thus, it would present a distinct advantage if the pressure sensitive adhesive hinge could be replaced by a hinge in which the plies were joined at one margin in a manner which was permanent, less likely to be pulled apart, and not dependent upon the hinge width for its security. Of course, a smaller (narrower) hinge also restores available copy area to the label plies.

### SUMMARY OF THE INVENTION

In accordance with the present invention, there is provided a resealable multi-ply booklet-type label that includes a first or base ply having an under side and an upper side and an amount of a pressure sensitive adhesive (PSA) material (defined below) on the under side to attach the label to an object of interest to be labeled. A second or upper ply is provided having an upper side and an under side and the upper side of the base ply and the under side of the upper ply are joined together permanently along a first or hinge edge or other hinge strip by an amount of a permanent adhesive (PA) material. Additional plies may be attached beneath the upper ply using a portion of the hinge strip or consecutive stacked hinges in a “sandwich” style construction.

While the term is defined in greater detail below, as used herein, a permanent adhesive may also be referred to as one which undergoes a phase change by solidifying during curing and which is not pressure sensitive; and which thereby provides “permanent” adhesion.

The upper side of the base ply and the under side of the upper ply are also releasably, resealably, joined along an opposite or second edge or along an outer release-reseal margin opposite the hinge or at one or more release-reseal strips spaced from a central hinge strip (depending on the label configuration). A dual layer release-reseal system is used which includes a layer of pressure sensitive adhesive material and an abutting layer (top/bottom) of a release coating such that the plies can be separated and resealed at a juncture therebetween.

In the dual layer reseal system, layers abutting in the assembled label may be applied to the corresponding plies in either order, either separately, one on each ply, or together as a combination on one of the plies. Thus, for example, the pressure sensitive adhesive may be applied to the upper side of the base ply or to the under side of the upper ply and the release coating may be applied on the whole of the opposite facing surface exclusive of the hinge area or a lesser area down to just as much of that surface as is covered by the pressure sensitive adhesive. The pressure sensitive adhesive also may be applied in an intermittent pattern along the opposite edge and also along the remaining opposed side edges, or in any other pattern if desired.

The release coating may be a varnish, lacquer, or any other coating which accomplishes the effect of a detackifying release medium, which generally reduces, but does not eliminate, tackiness or stickiness of pressure sensitive adhesive material and allows the pressure sensitive adhesive to adhere to a surface only lightly so that it may be peeled back and resealed. Additional label layers or plies may be added as required.

### BRIEF DESCRIPTION OF THE DRAWINGS

In the drawings wherein like numerals are utilized to designate like parts throughout the same:

FIG. 1a depicts a top view of a resealable, multi-ply label in accordance with the invention with an upper ply shown partially peeled back;

FIG. 1b depicts a view similar to that of FIG. 1a showing a modified embodiment;

FIGS. 2a and 2b depict cross-sectional views of alternate embodiments representative of either of the embodiments of FIGS. 1a and 1b;

FIG. 2c is a view of an embodiment similar to that shown in FIG. 2b with an additional middle label ply;

FIG. 2d depicts an alternative construction for the embodiment of FIG. 2c; and

FIGS. 3a and 3b depict yet another embodiment of a multi-ply label in accordance with the invention.

### DETAILED DESCRIPTION

One skilled in the art will recognize from the foregoing, and it is an important aspect of the present invention, that two distinct types or classes of adhesive materials are employed in the labels, namely, those characterized as “permanent” adhesive materials (also called “non-pressure sensitive” materials) and those characterized as “pressure-sensitive” adhesive materials. It is to be particularly appreciated that, as used herein, the term “permanent” or “non-pressure sensitive” adhesive is one that is tack-free in the cured or final adhesive state, (more characteristically permanent or non-pressure sensitive adhesive materials are adhesive materials that undergo a phase change and solidify during curing) in bonding plies together.

As a further clarification to this definition, a universally accepted reference text, The Concise Encyclopedia of Polymer Science and Engineering (New York, 1990.), states, at page 35, with respect to permanent or non-pressure sensitive adhesives that “Eventually, the adhesive must undergo a phase change, i.e., by cooling, solvent evaporation or reaction, to a solid in order for the joint to acquire the necessary strength to resist shearing forces.”

By definition, and as referred to herein, the class of adhesives known as “pressure-sensitive” adhesives (PSA) is contrasted as an exception to permanent or non-pressure sensitive adhesives in the next sentence of the above-mentioned reference publication which reads, “A notable exception is the category of pressure-sensitive adhesives, where no phase change occurs.” This also describes the t “pressure sensitive” as used herein. These materials remain tacky. Adhesion may be modified (reduced) by detackifying overlayers, or by using low-adhesion abutting surfaces, but the material does not solidify and so retains a degree of stickiness to the touch. Generally, bonds between layers made using pressure-sensitive adhesives can be pulled apart without damage to the layers whereas those made using permanent adhesives cannot. This is particularly true with respect to multi-ply paper labels.

Within a class, preference of one such adhesive over another particularly will depend upon a drying or curing system of a given label manufacturing press, along with materials composition and compatibility considerations.

An explanatory table which compares in concise form the two classes of adhesives used herein using facts well-known to those skilled in the art demonstrates that the relevant types of adhesives can be made in both pressure sensitive and permanent or non-pressure sensitive forms appears below:

| | | Non-Pressure Sensitive |
|---|---|---|
| Types of | Pressure Sensitive | Adhesives of this Type |
| of Adhesives | Adhesives of this Type | (i.e., “glues”) |
| Hot Melt | Remain “tacky” in final | Non-tacky or dry in |
| Adhesives | state (e.g., duct tape). | final state (e.g., craft |
| | | sticks). |
| Solvent-based | Remain “tacky” in final | Non-tacky or dry in |
| Adhesives | state (e.g., electrical | final state (e.g., model |
| | tape). | airplane glue). |
| Water-based | Remain “tacky” in final | Non-tacky or dry in |
| Adhesives | state (e.g., POST-IT ® brand | final state (e.g., |
| | notes, adhesive bandages | Elmer's ® glue). |
| | and masking tape). | |
| UV-curable | Remain “tacky” in final | Non-tacky or dry in |
| Adhesives | state. | final state (e.g., auto- |
| | | mobile construction). |
| EB-curable | Remain “tacky” in final | Non-tacky or dry in |
| Adhesives | state. | final state (e.g., floor |
| | | laminates). |

It should therefore be recognized that all of the pressure sensitive adhesive forms of the class remain “tacky” (sticky to the touch) in the final state, i.e., the manufactured product; whereas, members of the class of permanent or non-pressure sensitive adhesives undergo a phase change to a solid and become non-tacky or dry in the final state or in the finished label.

Permanent adhesive materials used in the label hinge, for example, are preferably selected from non-pressure sensitive versions of adhesives including, but not limited to glues, multiple-part epoxies, hot melt adhesives, solvent-based adhesives, water-based adhesives, and UV—(ultraviolet) and EB—(electron beam) curable adhesives. Chemical welding or bonding or even mechanical fastening means can also be employed. Examples of preferred permanent adhesive materials include UV-curable adhesives such as those available from RAD-CURE Corporation of Fairfield, New Jersey, including RAD-CURE 10PSLVA,B brand adhesive.

It is to be also particularly understood, as is known to those skilled in the art, that the aforecited references, along with other related art which utilize a “detackifying” or like technique, are necessarily predicated upon use of a pressure sensitive adhesive rather than a permanent adhesive; this is because only pressure sensitive adhesives are tacky in their final states and thus are the only adhesives that are capable of being, in turn, detackified. In other words, a permanent adhesive cannot be detackified, and therefore any reference to detackification necessarily implies exclusive use of pressure sensitive adhesive.

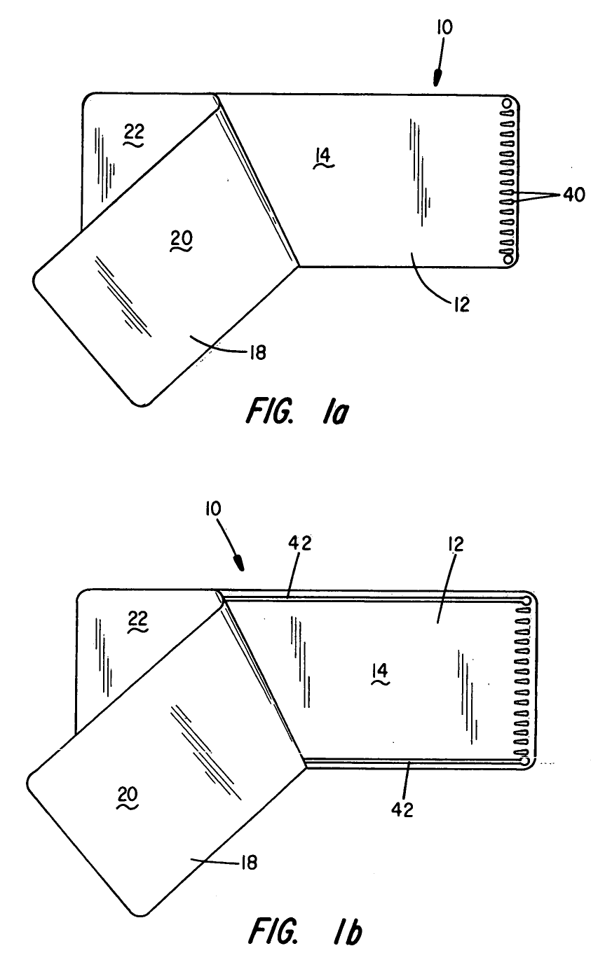

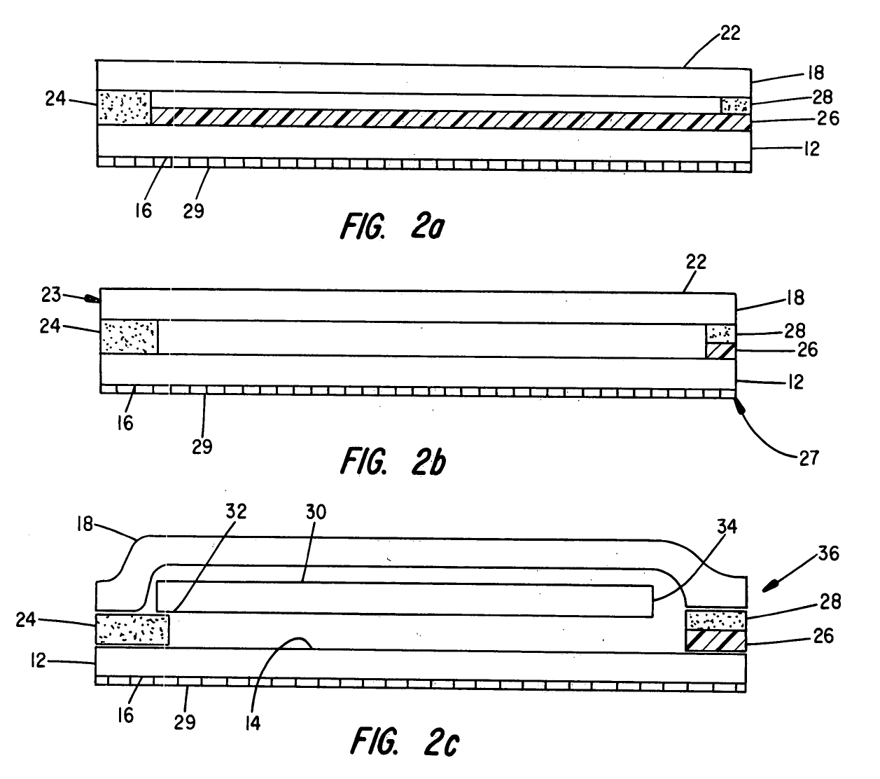

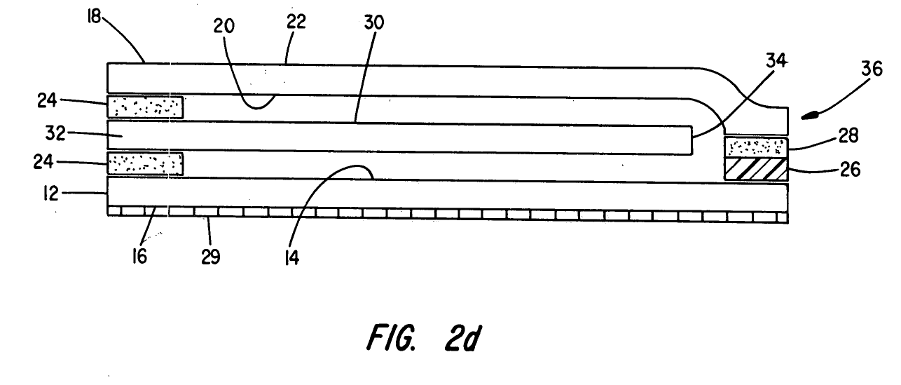

The detailed description contained herein in conjunction with the drawing figures presented is intended by way of example with respect to the inventive concept and not intended to be limiting in any way. With this in mind, FIGS. 1a and 1b show top views of a resealable, multi-ply label 10 having a first or base ply 12 having an upper side 14 and an under side 16 (FIGS. 2a-2c). Label 10 includes an upper or top ply 18 having an under side 20 and an upper side 22.

The plies 12 and 18 (and 30, as will be described) may be made of any suitable material that meets the physical and chemical compatibility requirements, along with desired aesthetic attributes and cost considerations, of a particular label. It is to be understood that where necessary, surfaces of the plies to be printed may receive one or more additional depositions of material to adjust the receptiveness to printing materials. Thus, an array of papers, plastics, and related materials may variously be employed for the plies, the surfaces of which may be adjusted as needed by those skilled in the art.

As best seen in FIGS. 2a-2c, the upper or top ply 18 is joined to the first or base ply 12 along a strip that is normally a hinge margin or edge 23 using a non-pressure sensitive permanent adhesive material 24 to form a binding or hinge. The adhesive material 24 is designed to cause permanent adhesions so that the upper or top ply 18 resists unintentional peeling away and removal from label 10 as is apt to occur with pressure sensitive adhesives often used in the hinged construction of such multi-ply labels even though such bonds may be referred to as “permanent”.

It is particularly to be noted that a consumer may, inadvertently, attempt to peel back or open a multi-ply label at an incorrect location. The permanent adhesive hinge of the invention will prevent an inadvertent splitting of the plies at the hinge. the heretofore unrecognized requirement of using two classes of adhesives in the manufacture of the labels of the present invention represents an important aspect of the present invention.

As seen in FIGS. 1a-b and 2a-d, a portion of the upper side 14 of the first or base ply 12 is provided with a layer of release coating 26 which may cover the entire area of the upper side 14 exclusive of regions having hinge adhesive material 24 in “zone coat” fashion as shown in FIG. 2a or some lesser amount as shown in FIGS. 2b-2d. As used herein, “layer” is intended to include any coating applied by a suitable deposition technique. The layer of release coating 26 is typically a varnish, lacquer, ink, or other coating that inhibits permanent adhesions. That is, the release coating generally reduces, but does not eliminate, the adhesive grip of pressure sensitive adhesives. A layer of pressure sensitive adhesive is shown at 28 in FIGS. 2a-2c. This material in conjunction with the release coating 26 enables release and resealing of the upper ply 18, and may be characterized, in combination, as a “release-reseal system”. A pattern of the pressure sensitive adhesive material in the release-reseal system may be in the form of a continuous, or a discontinuous or intermittent pattern, it only being necessary that the pattern of the pressure sensitive adhesive be substantially aligned with the release coating the plies are sealed and that it provide sufficient tack to prevent unaided or unintentional opening of the label as may occur, for example, in a product labeling assembly line or on a retail shelf.

FIG. 2c depicts an alternate construction that adds a third or middle ply 30 between base ply 12 and upper or top ply 18. Middle ply 30 is also permanently hinged by the hinge adhesive material 24 along one edge at 32 and has free sides and a free end 34. End 34 terminates before reaching the pressure sensitive adhesive 28 of the release-reseal system so that it is captured within the label 10 when the top ply 18 is held closed by the release-reseal system.

As can be seen in the FIGS. 2b and 2c, the release-reseal system may be preferably limited to a vicinity of a second edge as at 36 which is opposite the hinge margin or hinge edge or strip 23. Of course, the release-reseal system requires only that the release coating 26 be substantially aligned with the pressure sensitive adhesive 28 on the opposed surface of the adjacent ply.

As seen in FIGS. 1a and 1b, however, the pressure sensitive adhesive may be attached to the lower or base ply in an intermittent pattern generally along an edge as at 40 and along the two edges of remaining sides as at 42.

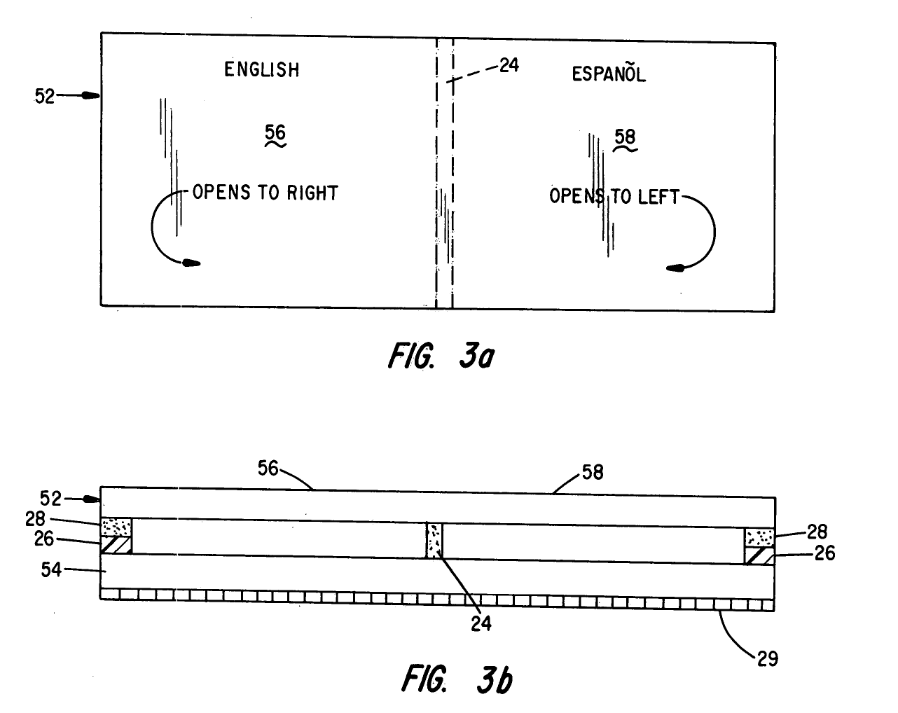

FIGS. 3a and 3b depict another embodiment which employs a center hinge of a permanent adhesive fixing, a central strip of an upper or top ply 52 to a central strip of lower or bottom ply 54 creating opposed leaves 56 and 58 which are releasably, resealably closed by systems similar to the previously described release-reseal systems. This enables, among other things, copy to be fully displayed in two languages, separate from each other.

Any of the labels may be provided, if desired, with an additional layer of adhesive 29 on the under or lower side of the base ply 12, 54 to attach the label to an object of interest to be labeled such as, for example, a bottle of a medicinal preparation or other health or beauty aid product. The label may be conveniently stored, delivered, and dispensed from a release liner (not shown) to protect the attachment surface.

FIG. 2d depicts an alternative embodiment of the three-ply label of FIG. 2c. Therein, a resealable, multi-ply label 10 has (i) a first or base ply 12 having an upper side 14 and an under side 16, (ii) an upper or top ply 18 having an under side 20 and an upper side 22, and (iii) a third middle or intermediate ply 30.

As with the embodiment of FIG. 2c, the plies 12, 18 and 30 in FIG. 2d may be made of any suitable material. Of course, additional plies 30 may be included in any booklet construction.

In the embodiment of FIG. 2d, base ply 12 is joined to middle ply 30, as is middle ply 30 to top ply 18, along a strip that is normally a full hinge margin or edge using a permanent adhesive material 24 to form a binding or pair of full hinges at 32.

Permanent adhesive material 24 is likewise designed to create permanent hinges so that middle ply 30 resists unintentional peeling away and removal from label 10. Top ply 18 is permanently hinged by hinge adhesive material 24 to middle ply 30. It can be seen, therefore, that this construction comprises an overall “adhesive sandwich” of alternating plies and adhesive materials at the hinge margin or hinge edge. Of course, one or more additional middle or intermediate plies can be added as desired. It is to be particularly appreciated that such a construction, if done utilizing pressure-sensitive adhesive hinge materials, almost without exception, will result in “adhesive ooze” and many problems attendant therewith in dispensing, application, and use of label 10.

As described relative to the embodiment of FIG. 2c, middle ply 30 in FIG. 2d also has free sides and a free end 34, which terminates short of the pressure-sensitive adhesive of the release-reseal system as was the case with the embodiment of FIG. 2c. The combination of a layer of pressure-sensitive adhesive material 28 and a layer of release coating 26 (in any order) forms a “release-reseal system” between plies 12 and 18. As illustrated, a portion of upper side 14 of base ply 12 is provided with a layer of release coating 26 which may cover an entire area of upper side 14, exclusive of regions having hinge adhesive material 24 as shown in FIG. 2a or some lesser amount as shown in FIGS. 2b and 2c.

This invention has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment and operating procedures, can be accomplished without departing from the scope of the invention itself.

For example, it will be appreciated that any of the aforedescribed graphics, coatings, materials, and release-reseal systems may be selectively provided in any suitable combination on labels constructed according to the present invention, for a particular desired use. Thus, in FIGS. 2c-d, the relative positions of coatings 26 and 28 could be interchanged.

It is also to be understood in general that any suitable alternatives may be employed to provide the resealable multi-ply label of the present invention.

Lastly, the choice, of course, of compositions, sizes, and strengths of various aforementioned components of the labels of the present invention are all a matter of design choice depending upon intended uses thereof.

What is claimed is:

1. A resealable booklet-type multi-ply label comprising:
(a) a base ply having an under side and an upper side and an amount of a label-attaching adhesive on said under side for attaching the label to an object of interest to be labeled;
(b) an upper ply having an under side and an upper side;
(c) an amount of a permanent, non-pressure sensitive adhesive material that is non-tacky in its final state in the label joining the upper side of said base ply and the under side of said upper ply together along a first edge thereby forming a hinge; and
(d) a release-reseal system comprising a layer of pressure-sensitive adhesive that remains tacky in its final state in the label and a layer of a release coating substantially aligned when sealed with said pressure sensitive adhesive releasably, resealably joining the upper side of said base ply and the under side of said upper ply generally along a second edge opposite said first edge such that the plies can be repeatably opened to said hinge as a booklet and resealed at a release-reseal juncture therebetween.

2. A resealable multi-ply label as in claim 1 wherein the permanent adhesive material of said hinge is selected from non-pressure sensitive forms of adhesives from the group consisting of hot melt adhesives, solvent-based adhesives, water-based adhesives, UV-curable and EB-curable adhesives.

3. A resealable multi-ply label as in claim 1 wherein said pressure sensitive layer of said release-reseal system is provided as a discontinuous pattern.

4. A resealable multi-ply label as in claim 1 wherein said release layer of said release-reseal system is provided on a location selected from the group consisting of the upper side of said base ply and the under side of said upper ply.

5. A resealable multi-ply label as in claim 1 wherein said release layer of said release-reseal system is substantially coextensive with the said pressure sensitive adhesive layer thereof.

6. A resealable multi-ply label as in claim 3 wherein said release layer of said release-reseal system is provided on a location selected from the group consisting of the upper side of said base ply and the under side of said upper ply.

7. A resealable multi-ply label as in claim 1 wherein the area covered by said release layer of said release-reseal system extends beyond the area of said pressure sensitive adhesive layer.

8. A resealable multi-ply label as in claim 3 wherein the area covered by said release layer of said release-reseal system extends beyond the area of said pressure sensitive adhesive layer.

9. A resealable multi-ply label as in claim 7 wherein said release layer of said release-reseal system is provided on a location selected from the group consisting of the upper side of said base ply and the under side of said upper ply.

10. A resealable multi-ply label as in claim 8 wherein said release layer of said release-reseal system is provided on a location selected from the group consisting of the upper side of said base ply and the under side of said upper ply.

11. A resealable multi-ply label as in claim 1 wherein said release-reseal system includes pressure sensitive adhesive applied as an intermittent pattern.

12. A resealable multi-ply label as in claim 2 wherein material forming said hinge is UV-curable.

13. A resealable multi-ply label as in claim 1 wherein said release-reseal system is applied generally along edges of remaining sides of said label.

14. A resealable multi-ply label as in claim 1 further comprising at least one intermediate ply having an under side and an upper side disposed between said base ply and said upper ply the under side of said intermediate ply being joined to the upper side of said base ply along an edge thereof by said amount of permanent, non-pressure sensitive adhesive material thereby forming a hinge.

15. A resealable multi-ply label as in claim 14 wherein remaining edges of said at least one intermediate ply are free edges.

16. A resealable multi-ply label as in claim 14 wherein said at least one intermediate ply is hinged to said base ply and said upper ply is consecutively hinged to said intermediate ply in layered fashion.

17. A resealable multi-ply label comprising:
(a) a base ply having an under side and an upper side and an amount of an adhesive on said under side to attach the label to an object of interest to be labeled;
(b) an upper ply having an under side and an upper side;
(c) an amount of a permanent, non-pressure sensitive adhesive material that is non-tacky in its final state in the label selected from the group of adhesives consisting of non-pressure sensitive forms of hot melt adhesives, non-pressure sensitive forms of solvent-based adhesives, non-pressure sensitive forms of water-based adhesives, non-pressure sensitive forms of UV-curable and non-pressure sensitive forms of EB-curable adhesives joining the upper side of said base ply and the under side of said upper ply together along a first edge thereby forming a hinge; and
(d) a release-reseal system comprising an intermittent pattern of pressure sensitive adhesive that remains tacky in its final state in the label and a layer of a release coating aligned when sealed with said pressure sensitive adhesive releasably, resealably joining the upper side of said base ply and the under side of said upper ply generally along a second edge opposite said first edge such that the plies can be repeatably opened to the hinge as a booklet and resealed at the juncture therebetween.

18. A resealable multi-ply label as in claim 17 further comprising at least one intermediate ply having an under side and an upper side disposed between said base ply and said upper ply the under side of said intermediate ply being joined to the upper side of said base ply along an edge thereof by said amount of permanent, non-pressure sensitive adhesive material thereby forming a hinge and wherein remaining edges of said at least one intermediate ply are free edges.

19. A resealable multi-ply label as in claim 14 wherein said release-reseal system is applied to edges of remaining sides of said label between said base ply and said upper ply.

20. A resealable multi-ply label as in claim 18 wherein said at least one intermediate ply is hinged to said base ply and said upper ply is consecutively hinged to said intermediate ply in layered fashion.

21. A resealable multi-ply label comprising:
(a) a base ply having an under side and an upper side and an amount of an adhesive on said under side to attach the label to an object of interest to be labeled;
(b) an upper ply having an under side and an upper side;
(c) an amount of a permanent, non-pressure sensitive adhesive material that is non-tacky in its final state in the label joining the upper side of said base ply and the under side of said upper ply together along a first strip thereby forming a hinge therebetween; and
(d) at least one outer release-reseal margin spaced from said hinge comprising a layer of pressure sensitive adhesive that remains tacky in its final state in the label and a layer of a release coating aligned When sealed With said pressure sensitive adhesive releasably, resealably joining the upper side of said base ply and the under side of said upper ply at least one outer margin spaced from said hinge such that the plies can be separated and opened to said hinge and resealed at the juncture therebetween.

22. A resealable multi-ply label as in claim 21 including a pair of said release-reseal margins spaced from and flanking said hinge.

23. A resealable multi-ply label as in claim 22 wherein said hinge generally joins a midpoint of said base ply and said upper ply.

24. A resealable multi-ply label as in claim 21 wherein the permanent adhesive material of said hinge is selected from non-pressure sensitive forms of adhesives from the group consisting of hot melt adhesives, solvent-based adhesives, water-based adhesives, UV-curable and EB-curable adhesives.

25. A resealable multi-ply label comprising:
(a) a base ply having an under side and an upper side and an amount of a label attaching adhesive on said under side to attach the label to an object of interest to be labeled;
(b) an upper ply having an under side and an upper side;
(c) an intermediate ply having an under side and an upper side;
(d) an amount of a permanent, non-pressure sensitive adhesive material that is non-tacky in its final state in the label joining the upper side of said base ply and the under side of said intermediate plug together along a first edge thereby forming a first hinge;
(e) an amount of a permanent, non-pressure sensitive adhesive material that is non-tacky in its final state in the label joining the upper side of said intermediate ply and the under side of said upper ply together along a first edge thereby forming a second hinge consecutive with said first hinge;
(f) a release-reseal system comprising a layer of pressure sensitive adhesive that remains tacky in its final state in the label and a layer of a release coating substantially aligned when sealed with said pressure sensitive adhesive releasably, resealably joining the upper side of said base ply and the under side of said upper ply along a second edge opposite said first edge such that the plies can be separated and resealed at the juncture therebetween.

26. A resealable multi-ply label as in claim 25 wherein the permanent adhesive material of said hinge is selected from non-pressure sensitive forms of adhesives from the group consisting of hot melt adhesives, solvent-based adhesives, water-based adhesives, UV-curable and EB-curable adhesives.

27. A resealable multi-ply label as in claim 25 wherein remaining edges of said intermediate ply are free edges.

28. A resealable multi-ply label as in claim 25 further comprising at least one additional intermediate ply consecutively hinged between said upper ply and said base ply.

29. A resealable multi-ply label as in claim 28 wherein remaining edges of said intermediate plies are free edges.
